(19) United States
(12) Patent Application Publication
(10) Pub. No.: US 2026/0189314 A1
(43) Pub. Date: Jul. 2, 2026

(54) Method for Synchronizing Master Device and Slave Device in Time and Optical Relay System

(71) Applicant: HMN TECHNOLOGIES CO., LIMITED, Tianjin (CN)

(72) Inventors: Xiaoyong QIN, Tianjin (CN); Shigui ZHANG, Tianjin (CN); Jiachao XU, Tianjin (CN); Jianping LI, Tianjin (CN); Xiaoyan FAN, Tianjin (CN)

(21) Appl. No.: 19/303,771

(22) Filed: Aug. 19, 2025

(30) Foreign Application Priority Data
Dec. 27, 2024 (CN) 202411953116.7

(51) Int. Cl. H04J 3/06; H04B 10/073; H04B 10/25; H04B 10/29

(52) U.S. Cl. CPC H04J 3/0667; H04B 10/073; H04B 10/25; H04B 10/29

(57) ABSTRACT

The present disclosure relates to the field of communication technologies, and provides a method for synchronizing a master device and a slave device in time and an optical relay system. The method includes: obtaining a first link length value and a second link length value by using measurement optical signals; obtaining a link length difference between a first transmission link and a second transmission link based on a difference between the first link length value and the second link length value by using a difference calculation algorithm for asymmetric optical fibers in a sending link and a receiving link; and compensating for a time deviation between the master device and the slave device based on the link length difference.

### CROSS-REFERENCE TO RELATED APPLICATION

The present disclosure claims priority to Chinese Patent Application No. 202411953116.7, filed on Dec. 27, 2024, which is incorporated herein by reference in its entirety.

### FIELD OF THE INVENTION

The present disclosure relates to the field of communication technologies, and in particular, to a method for synchronizing a master device and a slave device in time and an optical relay system.

### BACKGROUND OF THE INVENTION

A long-distance optical fiber communication system may span a distance of several hundred to tens of thousands of kilometers. To reduce impact of attenuation of an optical signal on communication quality during long-distance transmission, an optical relay system needs to be disposed in the long-distance optical fiber communication system to amplify the optical signal.

A high-precision time protocol (PTP) of IEEE1588v2 is commonly used in the optical relay system to synchronize a master device and a slave device in time. Time synchronization precision of the PTP is in a submicrosecond range. The master device is connected to a time server, and keeps consistent with coordinated universal time (UTC) through a global positioning system. The slave device performs time synchronization with the master device through a IEEE1588v2 protocol, so as to obtain accurate time.

A basic principle of the IEEE1588v2 protocol has an important assumption. To be specific, it is assumed that a transmission path delay of a message from the master device to the slave device is equal to that of a message from the slave device to the master device. However, in actual engineering implementation, due to various reasons such as asymmetric optical fibers between the master device and the slave device, the delays on the two transmission paths cannot be completely equal. Therefore, a time deviation between the master the slave device that is calculated based on the IEEE1588v2 protocol differs from an actual value. As a result, local time of the slave device cannot be synchronized with that of the master device.

Conventional manners for compensating for asymmetric delays in a sending link and a receiving link include a process of obtaining a link length by using an optical time domain reflectometer (OTDR) and a correspondence between fiber dispersion and the link length, and performing compensation at a port. However, the foregoing methods are difficult to implement, and require maintenance personnel to use equipment. Sites in the optical relay system needs to be measured one by one, which is time-consuming and costly. Meanwhile, in some special scenarios, such as for the optical relay system that is applied for underwater communication, the foregoing manners cannot be used for fiber measurement and compensation for the asymmetric delays in the sending link and the receiving link.

For the optical relay system, a coherent optical time domain reflectometry (COTDR) is commonly used to measure a fiber length. This technology is implemented by using a loopback unit within an optical amplification unit, and a detection pulse may pass through the sending link and the receiving link. Therefore, a length difference between the sending link and the receiving link cannot be obtained merely based on a measurement result of the COTDR, which leads to poor precision of time synchronization between the master device and the slave device of the optical relay system.

### SUMMARY OF THE INVENTION

Embodiments of the present disclosure provide a method for synchronizing a master device and a slave device in time and an optical relay system, to resolve a problem of poor precision of time synchronization between a master device and a slave device due to difficulties in compensating for asymmetric delays in a sending link and a receiving link of the optical relay system.

According to a first aspect, an embodiment of the present disclosure provides a method for synchronizing a master device and a slave device in time, including: obtaining a first link length value and a second link length value by using measurement optical signals, where the first link length value is a measured transmission length value between the master device and an optical repeater or between the master device and the slave device in a first transmission link including a link through which the master device sends an optical signal to the slave device, and the second link length value is a measured transmission length value between the slave device and the optical repeater or between the slave device and the master device in a second transmission link including a link through which the slave device sends an optical signal to the master device; obtaining a link length difference between the first transmission link and the second transmission link based on a difference between the first link length value and the second link length value; and compensating for a time deviation between the master device and the slave device based on the link length difference.

According to the method for synchronizing a master device and a slave device in time provided in the present disclosure, a sending link and a receiving link in a long-distance optical fiber communication system provided with an optical relay system can be measured, so as to obtain multiple first link length values and multiple second link length values that include different quantities of spans. Subsequently, a link length difference between the sending link and the receiving link is determined based on the multiple first link length values and the multiple second link length values, and the time deviation between the master device and the slave device is compensated for based on the link length difference. According to the method provided in the present disclosure, errors generated in a measurement process are reduced by means of measuring in segments and performing corresponding processing. In this way, precision of measuring a length of the transmission link in the optical relay system through the foregoing measurement manner is improved, thereby improving time synchronization precision.

In a feasible implementation, the measurement optical signals include a first measurement optical signal and a second measurement optical signal, and the obtaining a first link length value and a second link length value by using measurement optical signals includes: sending the first measurement optical signal to the slave device by using the master device; obtaining the first link length value based on the first measurement optical signal; sending the second measurement optical signal to the master device by using the slave device; and obtaining the second link length value based on the second measurement optical signal. In this way, the multiple first link length values between the master device and the slave device and the multiple second link length values between the slave device and the master device may be obtained separately, so as to achieve an effect of obtaining lengths of the first transmission link and the second transmission link. This facilitates determining of asymmetry between the first transmission link and the second transmission link in a subsequent process.

In a feasible implementation, the obtaining the first link length value based on the first measurement optical signal includes: obtaining a first scattering peak position and first transmission time of the first measurement optical signal; and determining, based on the first scattering peak position and the first transmission time, the first link length value that includes at least one first span, where the first span including at least one of a link between the master device and the optical repeater, a link between two adjacent optical repeaters, and a link between the optical repeater and the slave device in the first transmission link. The obtaining the second link length value based on the second measurement optical signal includes: obtaining a second scattering peak position and second transmission time of the second measurement optical signal; and determining, based on the second scattering peak position and the second transmission time, the second link length value that includes at least one second span including at least one of a link between the slave device and the optical repeater, a link between two adjacent optical repeaters, and a link between the optical repeater and the master device in the second transmission link. In this way, the spans in the first transmission link and the second transmission link can be divided, and the corresponding first link length value and second link length value can be obtained sequentially based on a quantity of spans included in the transmission link, so as to determine the link length difference between the sending link and the receiving link based on the first link length value and the corresponding second link length value, thereby avoiding a problem of significant errors in length measurement caused by overall measurement.

In a feasible implementation, the obtaining a link length difference between the first transmission link and the second transmission link based on a difference between the first link length value and the second link length value includes: obtaining, based on the first scattering peak position and the second scattering peak position, the first span corresponding to the first link length value and the second span corresponding to the second link length value, respectively; determining, based on the first span corresponding to the first link length and the second span corresponding to the second link length, a first length coefficient corresponding to the first link length value and/or the second link length value, wherein the first length coefficient includes a quantity of first spans included in the first link length value and/or second spans included in the second link length value; and obtaining the link length difference based on the first length coefficient. In this way, the spans corresponding to the first link length value and the second link length value are determined, so that the first length coefficient for each first link length value and each second link length value is obtained based on the quantity of included spans. In this case, the optical relay system is enabled to process the first link length value and the second link length value by using the first length coefficient, so as to obtain the link length difference between the first transmission link and the second transmission link. In this way, the optical relay system can obtain the corresponding link length difference by using measurement results of the multiple first transmission links and the multiple second transmission links, thereby reducing measurement errors during overall measurement and improving time synchronization precision.

In a feasible implementation, the obtaining the link length difference based on the first length coefficient includes: for each first span and corresponding second span, determining first lengths of the first span and the second span; determining a first length difference between the first span and the second span based on the first length coefficient, the first lengths, the first link length value, and the second link length value; and obtaining the link length difference based on the determined first length differences. In this way, the first length difference between the first span and the second span can be determined based on the first length coefficient, so that the optical relay system can obtain the link length difference by using the first length difference between each first span and the corresponding second span. Thus, measurement precision is improved, thereby improving precision of time synchronization between the master device and the slave device.

In a feasible implementation, the determining a first length difference between the first span and the second span based on the first length coefficient, the first length, the first link length value, and the second link length value includes: determining a relationship between the first link length value and the first length and a relationship between the second link length value and the first length based on the first length coefficient and the first length; determining the second link length value based on the first length coefficient; and determining the first length difference between the first span and the second span based on a difference between the relationship between the first link length value and the first length and the relationship between the second link length value and the first length. In this way, the optical relay system can determine the first length difference between each first span and the corresponding second span, so as to achieve an effect of obtaining a result that the sending link and the receiving link is asymmetric, thereby improving precision of the obtained link length difference.

In a feasible implementation, the determining a first length difference between the first span and the second span based on the first length coefficient, the first length, the first link length value, and the second link length value further includes: determining a relationship between the first link length and the first length and a relationship between the second link length and the first length based on the first length coefficient and the first length; determining the second link length based on the first length coefficient; determining first length values for the first lengths in sequence based on the relationship between the first link length and the first length and the relationship between the second link length and the first length; and determining the first length difference based on the first length values. In this way, the optical relay system can determine the first length difference between each first span and the corresponding second span, so as to achieve an effect of obtaining a result that the sending link and the receiving link is asymmetric, thereby improving precision of the obtained link length difference.

In a feasible implementation, the obtaining the link length difference based on the determined first length differences includes: determining the link length difference based on a sum of all first length differences. In this way, after the first length difference is obtained, the link length difference may be determined for a subsequent time deviation compensation process.

In a feasible implementation, before the obtaining a link length difference based on a difference between the first link length value and the second link length value, the method further includes: determining a first arrangement sequence for the first span and the second span based on a transmission sequence of the first measurement optical signal in the first transmission link and a transmission sequence of the second measurement optical signal in the second transmission link; and determining the second span based on the first arrangement sequence. In this way, the optical relay system can determine the second span corresponding to the first span based on the transmission sequence, thereby facilitating obtaining of the first length difference.

In a feasible implementation, the compensating for a time deviation between the master device and the slave device based on the link length difference includes: obtaining a to-be-compensated deviation based on a transmission speed of the measurement optical signals and the link length difference; and compensating for the time deviation between the master device and the slave device based on transmission time of the measurement optical signals and the to-be-compensated deviation. In this way, compensation for the time deviation between the master device and the slave device may be implemented, thereby improving precision of the time synchronization between the master device and the slave device.

In a feasible implementation, the compensating for the time deviation between the master device and the slave device based on transmission time of the measurement optical signals and the to-be-compensated deviation includes: determining a transmission time difference between the master device and the slave device based on the transmission time of the measurement optical signals; determining a correction coefficient based on the to-be-compensated deviation, the transmission time difference, and the link length difference; and compensating for a time deviation of the slave device based on the correction coefficient. In this way, the master device may compensate for the time deviation between the master device and multiple slave devices separately, to adapt to time deviation compensation in the optical relay system with multiple nodes, thereby improving the time synchronization precision of the master device for different slave devices in a same system.

According to a second aspect, an embodiment of the present disclosure further provides an optical relay system, including at least one master device, at least one slave device, at least one optical repeater, and an optical fiber. A sending link and a receiving link are established between the master device and the slave device through the optical fiber, and the optical repeater is disposed on the sending link and the receiving link. The master device includes a measurement unit and a compensation unit. The measurement unit is configured to obtain multiple first link length values and multiple second link length values by using measurement optical signals, wherein the first link length value is a measured transmission length value between the master device and any optical repeater or between the master device and the slave device in a first transmission link including a link through which the master device sends an optical signal to the slave device, and the second link length value is a measured transmission length value between the slave device and the optical repeater or between the slave device and the master device in a second transmission link including a link through which the slave device sends a further optical signal to the master device. The compensation unit is configured to obtain a link length difference between the first transmission link and the second transmission link based on a difference between each first link length value and the corresponding second link length value; and compensate for a time deviation between the master device and the slave device based on the link length difference.

It may be understood that the optical relay system provided in the second aspect performs the method for synchronizing a master device and a slave device in time described above. Therefore, for beneficial effects that can be achieved by the optical relay system, reference may be made to the beneficial effects in the method for synchronizing a master device and a slave device in time described above, and details are not described herein again.

### BRIEF DESCRIPTION OF THE DRAWINGS

To more clearly describe the technical solutions of the present disclosure, the accompanying drawings to be used in the embodiments are briefly illustrated below. Obviously, persons of ordinary skills in the art can also derive other accompanying drawings according to these accompanying drawings without an effective effort.

FIG. 1 is a schematic diagram of a structure of an optical fiber communication system provided with an optical repeater;

FIG. 2 is a schematic diagram of a principle of a time synchronization protocol;

FIG. 3 is a schematic diagram of a COTDR measurement process of an optical relay system;

FIG. 4 is a schematic diagram of a COTDR measurement result of an optical relay system;

FIG. 5 is a schematic flowchart of a method for synchronizing a master device and a slave device in time according to an embodiment of the present disclosure;

FIG. 6 is a schematic diagram of a structure of an optical relay system according to an embodiment of the present disclosure;

FIG. 7 is a schematic diagram of a span of an optical relay system according to an embodiment of the present disclosure;

FIG. 8 is a schematic diagram of a transmission link in an optical relay system according to an embodiment of the present disclosure;

FIG. 9 is a schematic flowchart of a compensation for a time deviation between a master device and a slave device according to an embodiment of the present disclosure;

FIG. 10 is a schematic diagram of a structure of a submarine cable communication system according to an embodiment of the present disclosure;

FIG. 11 is a schematic diagram of a structure of a loop submarine cable communication system according to an embodiment of the present disclosure;

FIG. 12 is a schematic flowchart of a time deviation compensation of a loop system according to an embodiment of the present disclosure; and

FIG. 13 is a schematic diagram of a structure of an optical relay system according to an embodiment of the present disclosure.

### DETAILED DESCRIPTION OF THE EMBODIMENTS

The technical solutions in accordance with the embodiments of the present disclosure are clearly described below in combination with the accompanying drawings in the embodiments of the present disclosure.

In description of the present disclosure, unless otherwise stated, “/” means or. For example, A/B may represent A or B. “and/or” in this specification refers to only an association relationship that describes associated objects, indicating presence of three relationships. For example, A and/or B may indicate presence of three cases: A alone, both A and B, and B alone. In addition, “at least one” means one or more; and “a plurality of” means two or more. Words “first” and “second” do not limit a quantity or an execution order, and do not limit definite differences.

It should also be understood that in the present disclosure, words such as “exemplary” or “for example” are used to indicate examples, illustrations, or clarifications. Any embodiments or design schemes described as “exemplary” or “for example” in the present disclosure should not be interpreted as being more preferred or advantageous than other embodiments or design schemes. Specifically, use of the words such as “exemplary” or “for example” is intended to present relevant concepts in a concrete way.

First, professional terms involved in the present disclosure are explained below.

A high-precision time protocol (PTP), also referred to as a precision time protocol, is a network time synchronization protocol that is mainly used to achieve high-precision time synchronization between devices in a communication network. IEEE1588v2 is a version of PTP, which can be used to implement time synchronization in a sub-millisecond range between devices in the communication network.

An optical relay amplifier (repeater, RPT), also referred to as an optical repeater or an optical amplifier, is a device in an optical fiber communication system that is used to enhance optical signals, which can extend a transmission distance of the optical signals. The optical relay amplifier is located in a middle section of an optical fiber transmission line, can receive an attenuated signal from a previous section of an optical fiber, amplify the received signal, and then send the enhanced signal to a next section of the optical fiber.

An erbium-doped fiber amplifier (EDFA) is an optical amplifier that injects erbium ions into the optical fiber and activates the erbium ions through a pump signal to achieve gain effects. The EDFA is a commonly used optical repeater in the optical fiber communication system, and the optical repeater in embodiments of the present disclosure may be the EDFA.

A span refers to a smallest optical transmission unit composed of a section of optical fiber and optical amplifiers (if any) at two ends. The span may be subdivided into various types, such as an optical amplifier span and an optical transmission span (OTS).

A coherent optical time domain reflectometry (COTDR) is a monitoring and fault diagnosis tool in the optical fiber communication system. The COTDR utilizes a difference frequency signal generated by self heterodyne of signal light and intrinsic light for detection.

In the optical fiber communication system, timing control and data exchange are required between devices to implement communication. If there are clock inconsistency and other issues between the devices, data transmission errors, losses, and other situations may occur, affecting an overall operation status of the optical fiber communication system. Therefore, a time synchronization technology needs to be utilized in the optical fiber communication systems to maintain time synchronization between various devices, thereby avoiding problems during a transmission process that are caused by inconsistent time.

A long-distance optical fiber communication system spans a distance of several hundred to tens of thousands of kilometers. Therefore, to reduce impact of attenuation of an optical signal on communication quality during long-distance transmission, an optical relay system may be disposed in the long-distance optical fiber communication system to amplify the optical signal. In the embodiments of the present disclosure, the optical relay system may also refer to an optical fiber communication system with an optical repeater.

Application scenarios of the embodiments of the present disclosure are described below with reference to the accompanying drawings.

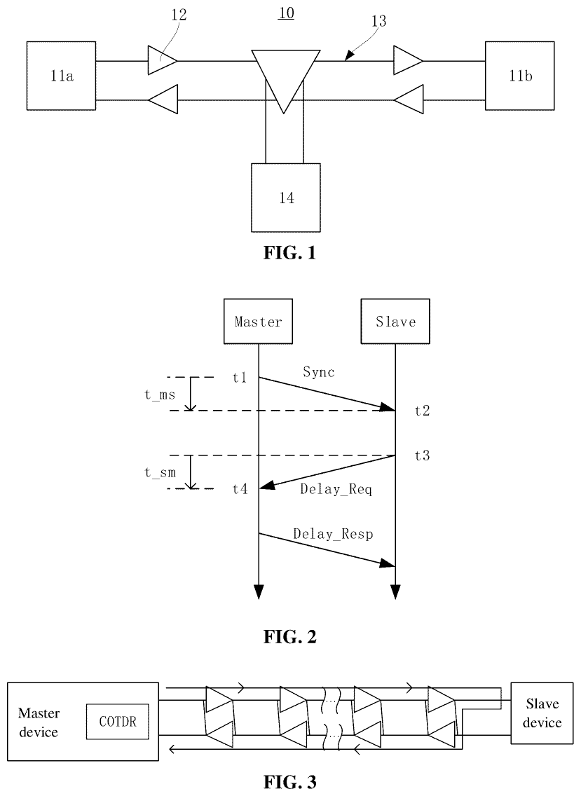

FIG. 1 is a schematic diagram of a structure of an optical fiber communication system provided with an optical repeater.

As shown in FIG. 1, an optical fiber communication system 10 may include a terminal station device 11a, a terminal station device 11b, an optical repeater 12, an optical cable 13, and a branch node 14. The terminal station device 11a, being a signal source as an example, may be a master device, and both the terminal station device 11b and the branch node 14 may be slave devices of the optical fiber communication system 10.

The master device (Master) refers to a device that sends information, which has initiative and control rights, and may initiate requests and control the slave device to complete tasks. The slave device (Slave) refers to a device that receives information, which can passively receive the requests from the master device and complete corresponding tasks according to the requests. In practical applications, the master device may also serve as a slave device and receive information sent from other devices. In other words, attributes of being a master device or a slave device for a device in a system are determined by capabilities of sending and receiving information. In the optical fiber communication system 10, the terminal station device 11b or the branch node 14 may also serve as a master device during transmission of an optical signal. This is not limited in the present disclosure.

In the optical fiber communication system 10, the terminal station device 11a may be provided with a time interface, which keeps consistent with coordinated universal time (UTC) by receiving signals from a global positioning system (GPS) or a Beidou navigation satellite system (BDS). Other devices in the optical fiber communication system 10 may achieve time synchronization with the optical fiber communication system 10 through time and a PTP in the terminal station device 11a.

FIG. 2 is a schematic diagram of a principle of a time synchronization protocol.

Taking an end-to-end (E2E) synchronization mechanism defined by the IEEE1588v2 protocol as an example, as shown in FIG. 2, the Master is provided with a master clock and the Slave is provided with a slave clock. The E2E mechanism allows the master and slave devices to interact with each other through a Sync message, a Delay_Req message, and a Delay_Resp message sequentially, so that the Slave can calculate a time deviation from the Master and adjust respective time to achieve time synchronization with the Master.

During the interaction, the Master may send the Sync message at a moment t1 and carry a t1 timestamp in the Sync message.

The Slave receives the Sync message at a moment t2, generates a t2 timestamp locally, and extracts the t1 timestamp from the message. After generating the t2 timestamp, the Slave sends the Delay_Req message at a moment t3 and generates a t3 timestamp locally.

The Master receives the Delay_Req message at a moment t4, generates a t4 timestamp locally, and then carries the t4 timestamp in the Delay_Resp message to be sent back to the Slave. The Slave receives the Delay_Resp message and extracts the t4 timestamp from the message. Finally, a Slave node obtains a set of timestamps (t1, t2, t3, and t4).

It is assumed that a sending link delay from the Master to the Slave is t_ms, a sending link delay from the Slave to the Master is t_sm, and a time deviation between the Slave and the Master is Offset, and it is satisfied that t2−t1=t_ms+Offset and t4−t3=t_sm−Offset.

On this basis, the time deviation satisfies that Offset=[(t2−t1)−(t4−t3)−(t_ms−t_sm)]/2. Because the IEEE1588v2 protocol defines t_ms=t_sm, that is, delays in the sending link and the receiving link between the Master and the Slave are symmetric, the final Offset is [(t2−t1)−(t4−t3)]/2. The Slave can achieve time synchronization with the Master by compensating for the time deviation Offset.

However, if there are asymmetry delays in the sending link and the receiving link between the Master and the Slave, a synchronization error needs to be introduced during the time synchronization process to compensate for the time deviation. Amplitude of the error is half of a difference between delays in the links in two directions. Therefore, for some high-precision synchronization scenarios, it is needed to compensate for asymmetric delays in the sending link and the receiving link between the Master and the Slave.

However, in a long-distance optical fiber communication system, such as the optical fiber communication system 10 shown in FIG. 1, an optical path difference may also be introduced due to inevitable errors in lengths of a sending fiber and a receiving fiber in a same fiber pair during a production process of the optical cable 13, and because the optical cable 13 may be affected by external environmental temperature and stress after being disposed. Further, taking the optical repeater 13 which is an EDFA as an example, there are also differences in fiber lengths of an erbium-doped fiber and various passive devices within the optical repeater 13. The foregoing factors may all bring in certain asymmetric delays in the sending link and the receiving link, and the asymmetry may become more severe when a transmission distance of the optical fiber communication system 10 increases, which affects time synchronization precision.

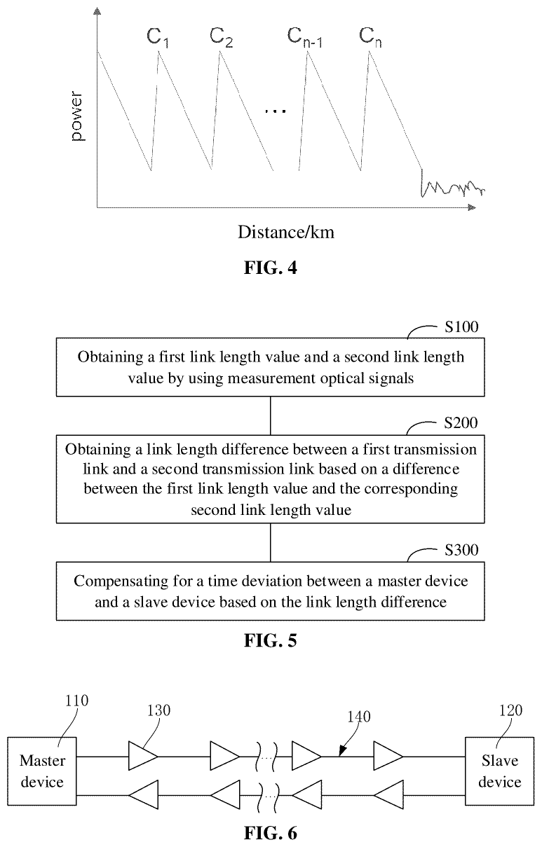

FIG. 3 is a schematic diagram of a COTDR measurement process of an optical relay system. FIG. 4 is a schematic diagram of a COTDR measurement result of an optical relay system.

As shown in FIG. 3, the master device in the optical relay system may use the COTDR to measure a transmission link between the master device and the slave device. According to a transmission process of detection light shown in FIG. 3, during a detection process, the detection light emitted by the COTDR may pass through a sending link and a receiving link of the master device.

As shown in FIG. 4, because an optical repeater is disposed on the transmission link in the optical relay system, there may be interface losses between the optical repeater and the transmission link. The detection light may generate a scattering peak at an interface position between the optical repeater and the transmission link, which increases scattering of the detection light. Influence of the optical repeater also increases power of returned light at a scattering peak position. Therefore, a position of the optical repeater in the sending link of the master device may be represented based on changes in the power of the returned light. For example, C₁ to Cₙ shown in FIG. 4 may correspond to scattering peak positions on a sending link between the COTDR and the slave devices shown in FIG. 3.

However, because the detection light emitted by the COTDR in the optical relay system may pass through the sending link and the receiving link of the master device for transmission and return, during calculation of a transmission distance between the scattering peak position and the master device, directly obtaining the transmission distance through transmission time of the detection light may cause a length difference between the sending link and the receiving link to be ignored in the transmission distance. Therefore, the length difference between the sending link and the receiving link cannot be obtained merely based on a measurement result of the COTDR, and delay asymmetry between the sending link and the receiving link cannot be compensated for.

To resolve a problem of poor precision of time synchronization between the master device and the slave device due to difficulties in compensating for asymmetric delays in the sending link and the receiving link of the optical relay system, the present disclosure provides a method for synchronizing a master device and a slave device in time. By combining device measurement and algorithms, a length difference between the sending link and the receiving link is obtained, thereby achieving accurate compensation for a time deviation between the master device and the slave device.

FIG. 5 is a schematic flowchart of a method for synchronizing a master device and a slave device in time according to an embodiment of the present disclosure.

As shown in FIG. 5, the method for synchronizing a master device and a slave device in time provided in the present disclosure includes the following steps S100 to S300.

S100. Obtaining a first link length value and a second link length value by using measurement optical signals.

In the embodiments of the present disclosure, there are multiple first link length values and multiple second link length values in the first transmission link and the second transmission link, and for the convenience of explanation, an optical repeater will be selected as an example to illustrate how to obtain the first link length value and the second link length value.

FIG. 6 is a schematic diagram of a structure of an optical relay system according to an embodiment of the present disclosure.

As shown in FIG. 6, the optical relay system is provided with a master device 110, a slave device 120, multiple optical repeaters 130, and an optical cable 140. There are two transmission links consisting of the optical repeaters 130 and the optical cable 140 between the master device 110 and the slave device 120, that is, a first transmission link and a second transmission link. The first transmission link is a link in the optical relay system through which the master device 110 sends an optical signal to the slave device 120, and the second transmission link is a link in the optical relay system through which the slave device 120 sends an optical signal to the master device 110.

It should be understood that since there is only one transmission direction for the optical signal in the optical repeater 130, and transmission directions of the optical signals in the first transmission link and the second transmission link are fixed. In a scenario where the optical relay system includes multiple slave devices, transmission directions of the first transmission link and the second transmission link also would not change.

In the embodiments of the present disclosure, the measurement optical signals may be optical signals generated by measurement modules disposed in the master device 110 and the slave device 120. The first link length value may be a measured transmission length value between the master device 110 and any optical repeater 130 or between the master device 110 and the slave device 120 in the first transmission link, and the second link length value may be a measured transmission length value between the slave device 120 and any optical repeater 130 or between the slave device 120 and the master device 110 in the second transmission link.

It should be noted that, between the master device 110 and the slave device 120, a quantity of the first link length values obtained through measurement is same as that of the second link length values obtained through measurement, and the quantities of the first link length values and the second link length values are related to a quantity of the optical repeaters 130 disposed on the sending link and the receiving link in the optical relay system. For example, if the quantity of the optical repeaters 130 disposed on the first transmission link is x, the quantity of the first link length values obtained through measurement is x+1; and if the quantity of the optical repeaters 130 disposed on the second transmission link is y, the quantity of the second link length values obtained through measurement is y+1. Typically, it is satisfied that x=y. For example, in the optical relay system, if there are 10 optical repeaters disposed on each of the first transmission link and the second transmission link, the quantities of the first link length values and the second link length values are both 11.

Further, in the embodiments of the present disclosure, the measurement modules for generating the measurement optical signals may be COTDR devices disposed in the master device 110 and the slave device 120, so that the master device 110 and the slave device 120 can generate measurement optical signals and send the same to each other, so as to measure length values of the first transmission link and the second transmission link, respectively.

For example, during the link length measurement process, the master device 110 may use the measurement module to send a first measurement optical signal to the slave device 120, and the slave device 120 may use the measurement module to send a second measurement optical signal to the master device 110. The optical relay system may obtain the first link length value and the second link length value based on the first measurement optical signal and the second measurement optical signal, respectively.

According to a measurement principle of the COTDR device, the COTDR keeps in contact with backward Rayleigh scattered light generated at an endpoint position in the optical cable 140 by monitoring the first measurement optical signal and the second measurement optical signal, that is, scattered light propagated back along the optical cable 140. Therefore, the optical relay system may obtain multiple first link length values and multiple second link length values by obtaining scattered optical signals of the first measurement optical signal and the second measurement optical signal at each optical repeater 130 and at a receiving end of the master device 110 or the slave device 120.

On this basis, when obtaining the first link length values and the second link length values, the optical relay system may determine each first link length value and each second link length value based on scattering peak positions of the first measurement optical signal and the second measurement optical signal in the optical cable and transmission time corresponding to the scattering peak positions.

In some embodiments of the present disclosure, the first transmission link and the second transmission link are transmission links composed of multiple sections of the optical cable 140 and multiple optical repeaters 130, and the optical repeaters 130 are devices that transmit signal light unidirectionally. Therefore, the first transmission link and the second transmission link include multiple spans, each of which corresponds to a transmission link composed of one section of the optical cable. Division of the spans is based on connection positions between the optical cable and the optical repeaters 130.

It should be understood that, according to meaning of the span, a span may contain at most one section of optical cable that can achieve communication without devices at a front end and a tail end, and optical transmission devices at both ends of the optical cable.

Specifically, multiple spans in the first transmission link may be referred to as a first span, and multiple spans in the second transmission link may be referred to as a second span. The first span includes at least one of a link between the master device 110 and an adjacent optical repeater 130, a link between two adjacent optical repeaters 130, and a link between the optical repeater 130 and the slave device 120 in the first transmission link. The second span includes at least one of a link between the slave device 120 and an adjacent optical repeater 130, a link between two adjacent optical repeaters 130, and a link between the optical repeater 130 and the master device 110 in the second transmission link.

In the embodiments of present disclosure, the optical relay system may sequentially determine each first link length value and each second link length value based on the scattering peak positions and the transmission time of the first measurement optical signal and the second measurement optical signal in the transmission link.

For example, the optical relay system may sequentially determine the first link length value including at least one first span and the second link length value including at least one second span by monitoring a first scattering peak position and first transmission time of the first measurement optical signal, and monitoring a second scattering peak position and second transmission time of the second measurement optical signal.

S200. Obtaining a link length difference between the first transmission link and the second transmission link based on a difference between the first link length value and the corresponding second link length value.

After the multiple first link length values and the multiple second link length values are obtained by the optical relay system, a difference calculation algorithm for asymmetric optical fibers in the sending link and the receiving link may be used to determine the difference between each first link length value and the corresponding second link length value. Thus, the link length difference is obtained based on the difference between each first link length value and the corresponding second link length value. In the embodiments of the present disclosure, the difference calculation algorithm for asymmetric optical fibers in the sending link and the receiving link may be an algorithm for determining the link length difference between the first transmission link and the second transmission link based on a correspondence between the first link length value and the second link length value.

In some embodiments of the present disclosure, the correspondence between the first link length value and the second link length value may be determined based on a transmission sequence of the measurement optical signals in the first transmission link and the second transmission link, and a correspondence between spans passed through during the transmission process.

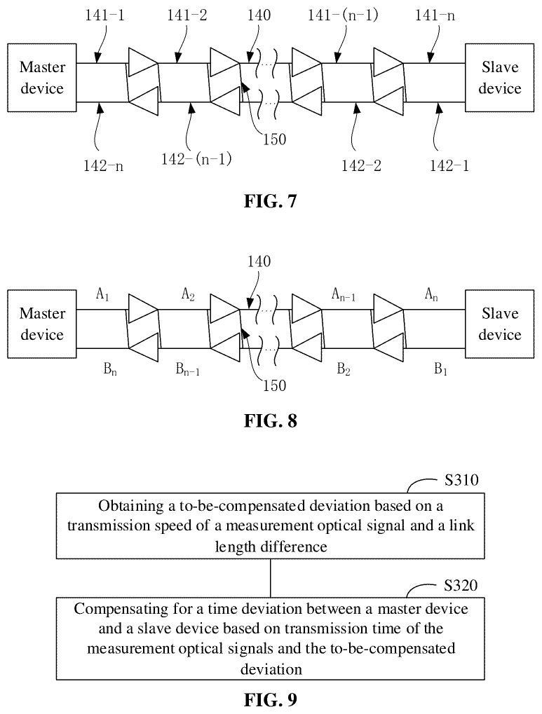

FIG. 7 is a schematic diagram of a span of an optical relay system according to an embodiment of the present disclosure.

As shown in FIG. 7, based on the transmission directions of the first transmission link and the second transmission link, the optical cable 140 close to the master device 110 in the first transmission link may be a first span 141-1, and a corresponding second span 142-1 is the optical cable 140 close to the slave device 120 in the second transmission link. According to the transmission sequence, the first span 141-2 corresponds to the second span 142-2, until a first span 141-n close to the slave device 120 in the first transmission link corresponds to a second span 142-n close to the master device 110 in the second transmission link, where n is a positive integer.

Therefore, before step S200, the optical relay system may determine a first arrangement sequence for the first span and the second span based on a transmission sequence of the first measurement optical signal in the first transmission link and a transmission sequence of the second measurement optical signal in the second transmission link; and further determine the respective second span corresponding to each first span based on the first arrangement sequence.

After determining the second span corresponding to each first span, the optical relay system may determine the second link length value corresponding to the first link length value based on the first arrangement sequence and the first span included in the first link length value and the second span included in the second link length value.

As shown in FIG. 7, according to a measurement principle of the COTDR, the transmission direction of the first measurement optical signal may change after the first measurement optical signal is in contact with a breakpoint in the optical cable in the first transmission link. Therefore, at an output end of the optical cable 140 in each first span, the first measurement optical signal may generate scattered light with a direction opposite to a propagation direction, which may be returned to the master device 110, thereby achieving an effect of measuring the first transmission link.

For example, during the process in which the master device 110 sends the first measurement optical signal to the slave device 120 through the first transmission link, when the first measurement optical signal is transmitted to an end of the first span 141-1 that is close to the optical repeater 130, because a connection interface between the optical cable 140 and the optical repeater 130 is different from the optical cable 140, the first measurement optical signal may generate scattered light at this end, which returns to the master device 110 through the first span 141-1.

It should be understood that due to irreversible transmission directions of the optical repeaters 130 in the first transmission link and the second transmission link, some first measurement optical signals need to be transmitted to the master device 110 through the second transmission link during a process of being reflected back to the master device 110.

When the first measurement optical signal is transmitted to the first span 141-2 and even the first span 141-n, after being transmitted to an optical repeater 130, the generated scattered light may be affected by the transmission direction of the optical repeater 130, and cannot be returned to the master device 110 through the first transmission link. In this case, the scattered light may be transmitted to the second transmission link through a connected optical cable 150 disposed at two ends of the optical repeaters 130 in the first transmission link and the second transmission link, so that the scattered light may be returned to the master device 110 through the second transmission link. For example, the first measurement optical signal is transmitted to an optical repeater 130-12 at one end of the first span 141-2. While being returned, the scattered light may first pass through the first span 141-2, and then may be transmitted to the second transmission link through a connected optical cable 150 between the first span 141-2 and a second span 142-(n−1), so that the first measurement optical signal may be returned to the master device 110 through the second span 142-n.

Similarly, during the process in which the slave device 120 sends the second measurement optical signal to the master device 110 through the second transmission link, the second measurement optical signal may be transmitted back to the slave device 120 through the second span 142-1 after coming into contact with an optical repeater 130-21 connected to the second span 142-1. When the second measurement optical signal is transmitted to the second span 142-2, the scattered light may be transmitted to the first transmission link through a connected optical cable 150 between the second span 142-2 and a first span 141-(n−1), and then may be transmitted back to the slave device 120 through the first span 141-n.

In the embodiments of the present disclosure, the optical relay system may obtain the first span and the second span that correspond to each first link length value and each second link length value based on the first scattering peak position, the second scattering peak position, and the manners for determining transmission spans corresponding to the first link length value and the second link length value.

Subsequently, a first length coefficient corresponding to each first link length value and each second link length value is determined based on the first span corresponding to the first link length and the second span corresponding to the second link length. The first length coefficient includes a quantity of first spans and second spans included in the first link length value or the second link length value. Specifically, the first length coefficient may include a quantity of all first spans and all second spans in the first link length value or the second link length value. The coefficient may be determined based on the corresponding a quantity of the first spans and the second spans included in the first link length value or the second link length value, and a first length coefficient corresponding to first spans and second spans that are not included in the first link length value or the second link length value may be 0.

FIG. 8 is a schematic diagram of a transmission link in an optical relay system according to an embodiment of the present disclosure.

For example, after the first length coefficient is determined by the optical relay system, to facilitate description of a relationship between the first span and each first link length value and a relationship between the second span and each second link length value, the optical relay system may preset lengths for each first span and each second span to determine a first length.

It should be understood that the first length is assumed to be a length of the first span or the second span in the optical relay system, and therefore the first length is an unknown number. As shown in FIG. 8, that the optical relay system includes n first spans and n second spans is used as an example. The optical relay system may determine that first lengths of the first spans are A₁-Aₙ, and that first lengths of the second spans are B₁-Bₙ. The first span corresponding to A₁ is the first span close to an end of the master device 110 in the first transmission link, and the second span corresponding to B₁ is the second span close to an end of the slave device 120 in the second transmission link.

After the optical relay system obtains each first link length value and each second link length value through measurement, and determines the first length coefficient and the first length, a first length difference between each first span and the second span corresponding to the first span in the optical relay system may be determined based on the first length coefficient, the first length, the first link length value, and the second link length value.

A correspondence between the first span and the second span may be determined based on the foregoing manner of determining the correspondence according to the transmission sequence. In this embodiment, the first span corresponding to A₁ corresponds to the second span corresponding to B₁, and the first span corresponding to Aₙ corresponds to the second span corresponding to Bₙ.

In the embodiments of the present disclosure, the first length coefficient includes multiple coefficients, and a quantity of the coefficients is same as a sum of the quantities of the first spans and the second spans. Moreover, each first link length value or each second link length value has a unique and corresponding first length coefficient. Taking the optical relay system shown in FIG. 8 as an example, the first length coefficient may include 2n coefficients, and at least one coefficient has a value of 0.

Further, a relationship between each first link length value and the first length and a relationship between each second link length value and the first length may be expressed by using the first length coefficient and the first length. For example, the relationship between each first link length value and the first length and the relationship between each second link length value and the first length may be obtained by respectively multiplying all coefficients in the first length coefficient with the corresponding first length and summing products up.

Illustratively, in the optical relay system, the quantity of the first link length values is same as that of the first spans, and the quantity of the second link length values is same as that of the second spans. Typically, the quantity of the first spans is same as that of the second spans. When expressing the relationship of the first length in the optical relay system, the first link length values may be set to Cₘ₁-Cₘₙ, and the second link length values may be set to Cₛ₁-Cₛₙ. Arrangement and correspondence manners between the Cₘ₁-Cₘₙ and the Cₛ₁-Cₛₙ may be determined based on a manner of determining the first arrangement sequence in the foregoing embodiments.

Relationships between Cₘ₁-Cₘₙ and Cₛ₁-Cₛₙ and the first length may be determined based on the first length coefficient corresponding to Cₘ₁-Cₘₙ and Cₛ₁-Cₛₙ. It should be understood that a distance value measured by the measurement optical signal is a value of a distance traveled by the measurement optical signal during its transmission and return in the transmission link, and the first link length value and the second link length value are half of a transmission distance of the measurement optical signal in the transmission link. Therefore, in some embodiments of the present disclosure, the relationship between the first link length value and the first length may be expressed as the following equations:

$${C}_{m 1} = ( {A}_{1} + {A}_{1} ) / 2 ; \qquad ( 1.1 )$$

$${C}_{m 2} = ( {A}_{1} + {A}_{2} + {A}_{2} + {B}_{n} ) / 2 ; \qquad ( 1.2 )$$

$${C}_{m 3} = ( {A}_{1} + {A}_{2} + {A}_{3} + {A}_{3} + {B}_{n - 1} + {B}_{n} ) / 2 ; \qquad ( 1.3 )$$

$${C}_{m ( n - 1 )} = ( {A}_{1} + {A}_{2} + … + {A}_{n - 1} + {A}_{n - 1} + {B}_{3} + {B}_{4} + … + {B}_{n} ) / 2 ; \qquad ( 1. n - 1 )$$

$${C}_{mn} = ( {A}_{1} + {A}_{2} + … + {A}_{n - 1} + {A}_{n} + {A}_{n} + {B}_{2} + {B}_{3} + … + {B}_{n} ) / 2 ; \qquad ( 1. n )$$

Correspondingly, the relationship between the second link length value and the first length may be expressed as the following equations:

$${C}_{s 1} = ( {B}_{1} + {B}_{1} ) / 2 ; \qquad ( 2.1 )$$

$${C}_{s 2} = ( {B}_{1} + {B}_{2} + {B}_{2} + {A}_{n} ) / 2 ; \qquad ( 2.2 )$$

$${C}_{s 3} = ( {B}_{1} + {B}_{2} + {B}_{3} + {B}_{3} + {A}_{n - 1} + {A}_{n} ) / 2 ; \qquad ( 2.3 )$$

$${C}_{s ( n - 1 )} = ( {B}_{1} + {B}_{2} + … + {B}_{n - 1} + {B}_{n - 1} + {A}_{3} + {A}_{4} + … + {A}_{n} ) / 2 ; \qquad ( 2. n - 1 )$$

$${C}_{s n} = ( {B}_{1} + {B}_{2} + … + {B}_{n - 1} + {B}_{n} + {B}_{n} + {A}_{2} + {A}_{3} + … + {A}_{n} ) / 2 ; \qquad ( 2. n )$$

On this basis, a difference between the relationship between the first link length value and the first length and the relationship between the corresponding second link length value and the first length may be determined based on the correspondence between the first link length value and the second link length value. That is, a difference between A₁ and B₁ is determined by calculating a difference between Cₘ₁ and Cₛ₁, that is, subtracting the equation (1.1) from the equation (2.1), where Cₘ₁ and Cₛ₁ may be length values obtained based on the first measurement optical signal and the second measurement optical signal.

Subsequently, a difference between Aₙ and Bₙ in a difference between Cₘₙ and Cₛₙ is obtained based on the difference between A₁ and B₁. Subsequently, a difference between A₂ and B₂, a difference between A₃ and B₃, and a difference between Aₙ₋₁ and Bₙ₋₁ are sequentially obtained based on a difference between Cₘ₂ and Cₛ₂, a difference between Cₘ₃ and Cₛ₃, and even a difference between Cₘ₍ₙ₋₁₎ and Cₛ₍ₙ₋₁₎.

The link length difference between the first transmission link and the second transmission link may be obtained based on the foregoing determined first length difference. Illustratively, the link length difference may be determined based on a sum of all first length differences.

In some other embodiments of the present disclosure, during the process of obtaining the link length difference by the optical relay system, the relationships between the first link length value and the second link length value and the first length may also be described through a linear equation system, so as to determine the corresponding first length difference.

It may be learned from the foregoing embodiments that the distance value measured by the measurement optical signal is the value of the distance traveled by the measurement optical signal during its transmission and return in the transmission link, and the first link length value and the second link length value are half of the transmission distance of the measurement optical signal in the transmission link. Therefore, a distance obtained through a sum of products of the first length coefficient and the first lengths is twice of the first link length value or the second link length value corresponding to the first length coefficient.

Therefore, relationships between the first link length value and the second link length value and the first length coefficient and the first length may be expressed by using the following equations.

$${\sum }_{i = 1}^{n} {A}_{i} + {A}_{n} + {\sum }_{j = 2}^{n} {B}_{n - ( j - 2 )} = 2 {C}_{mn} ; \qquad ( 1 )$$

$${\sum }_{j = 2}^{n} {A}_{n - ( j - 2 )} + {\sum }_{i = 1}^{n} {B}_{i} + {B}_{n} = 2 {C}_{s n} \qquad ( 2 )$$

It should be understood that in this embodiment, n is a positive integer greater than or equal to 2, and i and j are both positive integers. In addition, the foregoing expressions are merely for exemplary description, and the relationships between the first link length value and the second link length value and the first length coefficient and the first length may be obtained based on a specific value of n by the optical relay system. For example, according to the equations (1) and (2), the relationships between the first link length value and the second link length value and the first length coefficient and the first length may also be expressed as:

$${A}_{1} + {A}_{1} = 2 {C}_{m 1} ; \qquad ( 3.1 )$$

$${A}_{1} + {A}_{2} + {A}_{2} + {B}_{n} = 2 {C}_{m 2} ; \qquad ( 3.2 )$$

$${A}_{1} + {A}_{2} + {A}_{3} + {A}_{3} + {B}_{n - 1} + {B}_{n} = 2 {C}_{m 3} ; \qquad ( 3.3 )$$

$${A}_{1} + {A}_{2} + … + {A}_{n - 1} + {A}_{n - 1} + {B}_{3} + {B}_{4} + … + {B}_{n} = 2 {C}_{m ( n - 1 )} ; \qquad ( 3. n - 1 )$$

$${A}_{1} + {A}_{2} + … + {A}_{n - 1} + {A}_{n} + {A}_{n} + {B}_{2} + {B}_{3} + … + {B}_{n} = 2 {C}_{m n} ; \qquad ( 3. n )$$

$${B}_{1} + {B}_{1} = 2 {C}_{s 1} ; \qquad ( 3. n + 1 )$$

$${A}_{n} + {B}_{1} + {B}_{2} + {B}_{2} = 2 {C}_{s 2} ; \qquad ( 3. n + 2 )$$

$${A}_{n - 1} + {A}_{n} + {B}_{1} + {B}_{2} + {B}_{3} + {B}_{3} = 2 {C}_{s 3} ; \qquad ( 3. n + 3 )$$

$${A}_{3} + {A}_{4} + … + {A}_{n} + {B}_{1} + {B}_{2} + … + {B}_{n - 1} + {B}_{n - 1} = 2 {C}_{s ( n - 1 )} ; \qquad ( 3. n - 1 )$$

$${A}_{2} + {A}_{3} + … + {A}_{n} + {B}_{1} + {B}_{2} + … + {B}_{n - 1} + {B}_{n} + {B}_{n} = 2 {C}_{s n} ; \qquad ( 3. n )$$

On the basis of the various expressions described above, an expression group of the first link length value, the second link length value, and the first length may be expressed in a form of matrix multiplication by the optical relay system, so as to obtain a matrix corresponding to the first link length value and the second link length value by multiplying two matrices. Therefore, the relationships between the first link length value and the second link length value and the first length may be expressed as a product of a coefficient matrix \vec{A} and an unknown vector \vec{X}, that is, the following equation (3).

$$( \begin{matrix}2 & 0 & 0 & … & 0 & 0 & … & 0 & 0 & 0 \\ 1 & 2 & 0 & … & 0 & 0 & … & 0 & 0 & 0 \\ 1 & 1 & 2 & … & 0 & 0 & … & 0 & 0 & 0 \\ ⋮ & ⋮ & ⋮ & ⋱ & ⋮ & ⋮ & ⋮ & ⋮ & ⋮ & ⋮ \\ 1 & 1 & 1 & … & 2 & 0 & … & 1 & 1 & 1 \\ 0 & 0 & 0 & … & 0 & 2 & 0 & 0 & … & 0 \\ 0 & 0 & 0 & … & 1 & 1 & 2 & 0 & … & 0 \\ 0 & 0 & 0 & … & 1 & 1 & 1 & 2 & … & 0 \\ ⋮ & ⋮ & ⋮ & ⋱ & ⋮ & ⋮ & ⋮ & ⋮ & … & ⋮ \\ 0 & 1 & 1 & … & 1 & 1 & 1 & 1 & … & 2\end{matrix} ) \cdot ( \begin{matrix}{A}_{1} \\ {A}_{2} \\ {A}_{3} \\ ⋮ \\ {A}_{n} \\ {B}_{1} \\ {B}_{2} \\ {B}_{3} \\ ⋮ \\ {B}_{n}\end{matrix} ) = ( \begin{matrix}2 {C}_{m 1} \\ 2 {C}_{m 2} \\ 2 {C}_{m 3} \\ ⋮ \\ 2 {C}_{m n} \\ 2 {C}_{s 1} \\ 2 {C}_{s 2} \\ 2 {C}_{s 3} \\ ⋮ \\ 2 {C}_{s n}\end{matrix} ) ; \qquad ( 3 )$$

\vec{A} is a coefficient matrix before a multiplication sign. The \vec{A} may be obtained through the first length coefficient or by using the equations (1) and (2) in the method described above, which will not be elaborated herein. \vec{X} is a preset unknown number of the optical relay system; and in this embodiment, may be an unknown number determined for each first length by the optical relay system. A result matrix \vec{C} obtained through multiplication is the first link length value and the second link length value that are obtained based on the first measurement optical signal and the second measurement optical signal, respectively.

In the embodiments of the present disclosure, since values in the result matrix are known values, a corresponding value of each unknown number in an unknown number matrix \vec{X} may be determined according to an equation of \vec{X}=\vec{A}⁻¹·\vec{C}. It should be understood that a necessary and sufficient condition for equation (3) to have only one set of solutions is that the coefficient matrix \vec{A} is full rank, and a necessary and sufficient condition for the coefficient matrix \vec{A} to be full rank is that a determinant |A| corresponding to the coefficient matrix is not 0. Therefore, provided that it is determined that a value of the determinant |A| in the optical relay system is not 0, the first length value corresponding to each first length may be determined according to equation (3), and the first length difference may be obtained based on the first length value.

A value of the determinant |A| may be determined by finding a sub-determinant. It should be understood that the determinant |A| may be a determinant with a size of 2n×2n. In the process of finding the sub-determinant, the determinant |A| may be split into four determinants with a size of n×n to determine the value of the determinant |A|.

Illustratively, the determinant satisfies that

$$\vert A \vert = \vert \begin{matrix}A 1 & A 2 \\ A 3 & A 4\end{matrix} \vert = \vert A 1 \vert \times \vert A 4 \vert - \vert A 2 \vert \times \vert A 3 \vert .$$

It may be learned from the coefficient matrix in the foregoing equation (3) that the four sub-determinants may be specifically expressed as:

$$\vert A 1 \vert = \vert \begin{matrix}2 & 0 & 0 & … & 0 \\ 1 & 2 & 0 & … & 0 \\ 1 & 1 & 2 & … & 0 \\ ⋮ & ⋮ & ⋮ & ⋱ & ⋮ \\ 1 & 1 & 1 & … & 2\end{matrix} \vert ;$$

$$\vert A 2 \vert = \vert \begin{matrix}0 & … & 0 & 0 & 0 \\ 0 & … & 0 & 0 & 1 \\ 0 & … & 0 & 1 & 1 \\ ⋮ & ⋰ & ⋮ & ⋮ & ⋮ \\ 0 & 1 & 1 & 1 & 1\end{matrix} \vert ;$$

$$\vert A 3 \vert = \vert \begin{matrix}0 & 0 & 0 & … & 0 \\ 0 & 0 & 0 & … & 1 \\ 0 & 0 & 0 & … & 1 \\ ⋮ & ⋮ & ⋮ & ⋱ & ⋮ \\ 0 & 1 & 1 & … & 1\end{matrix} \vert ; and$$

$$\vert A 4 \vert = \vert \begin{matrix}2 & 0 & 0 & … & 0 \\ 1 & 2 & 0 & … & 0 \\ 1 & 1 & 2 & … & 0 \\ ⋮ & ⋮ & ⋮ & ⋱ & ⋮ \\ 1 & 1 & 1 & … & 2\end{matrix} \vert .$$

|A1| and |A4| may be transformed into diagonal determinants through linear transformation, and values thereof must not be 0; while |A2| and |A3| are determinants containing diagonals and half of which are 0, and values thereof must be 0. On this basis, if the value of the determinant |A| is not 0, the corresponding first length value of each first length may be determined by the optical relay system according to the foregoing equation (3), and the first length difference may be determined after the first length value is obtained.

In the embodiments, after first length values are obtained, the first length differences may be sequentially determined based on first length values corresponding to A₁-Aₙ and B₁-Bₙ and according to a correspondence between the first span and the second span. After the first length differences are obtained, the link length difference is determined based on the sum of the first length differences.

In some other embodiments, a sum of first length values corresponding to the first spans and a sum of first length values corresponding to the second spans may also be directly obtained through the first length values, and then the link length difference may be obtained by means of obtaining a difference by the optical relay system. The manner of obtaining the link length difference after the first length values are obtained is not limited in the embodiments of the present disclosure.

S300. Compensating for a time deviation between the master device and the slave device based on the link length difference.

After obtaining the link length difference, link symmetry on the first transmission link and the second transmission link may be determined by the optical relay system based on the link length difference for compensating for the time deviation between the master device 110 and the slave device 120, thereby improving time synchronization precision of the optical relay system.

FIG. 9 is a schematic flowchart of a compensation for a time deviation between a master device and a slave device according to an embodiment of the present disclosure.

As shown in FIG. 9, in some embodiments of the present disclosure, after the link length difference is obtained, the time deviation between the master device 110 and the slave device 120 may be compensated for through steps S310 and S320.

S310. Obtaining a to-be-compensated deviation based on a transmission speed of the measurement optical signals and the link length difference.

In the embodiments of the present disclosure, the transmission speed of the measurement optical signals may be determined based on a speed of light and effects of the optical cable on the speed of light. For example, the transmission speed of the measurement optical signals may be the speed of light.

Illustratively, the to-be-compensated deviation satisfies that Δt_{L}=nΔL/2c, where Δt_{L} represents the to-be-compensated deviation, ΔL represents the link length difference, c represents the speed of light, and n represents a quantity of spans between the master device 110 and the slave device 120.

S320. Compensating for the time deviation between the master device and the slave device based on transmission time of the measurement optical signals and the to-be-compensated deviation.

After obtaining the to-be-compensated deviation, the optical relay system may compensate for the time deviation between the master device 110 and the slave device 120 based on the transmission time of the measurement optical signal and the to-be-compensated deviation.

Specifically, the process of compensating for time deviation may be performed based on the calculation process of the time deviation Offset provided in the foregoing embodiments. After the time deviation Offset is obtained when the delays in the sending link and the receiving link between the master device 110 and the slave device 120 are symmetric, the time deviation Offset is corrected according to the to-be-compensated deviation Δt_{L}, thereby avoiding a situation where an effect of compensating for the time deviation is affected by asymmetric delays in the sending link and the receiving link when compensating for the time deviation by the slave device 120.

It should be understood that in an optical fiber communication system, there may be multiple slave devices that require time synchronization. For example, in a submarine cable communication system, each submarine master base station included therein may serve as a slave device for time synchronization with the master device.

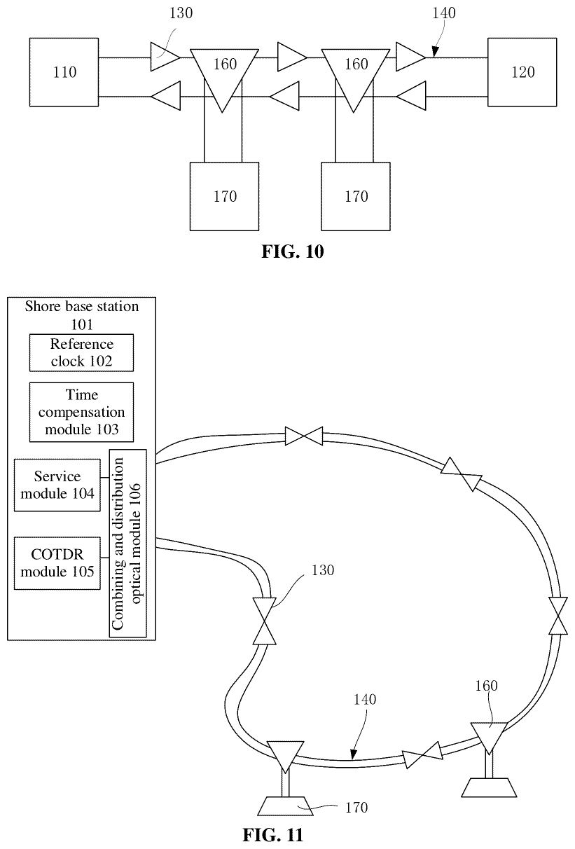

FIG. 10 is a schematic diagram of a structure of a submarine cable communication system according to an embodiment of the present disclosure.

As shown in FIG. 10, the submarine cable communication system may include a master device 110, a slave device 120, an optical repeater 130, an optical cable 140, a branch unit 160, and a submarine master base station 170. The submarine master base station 170 is connected to a sending link and a receiving link between the master device 110 and the slave device 120 through the branch unit 160.

Because the submarine master base station 170 needs to perform tasks such as ocean environment observation and submarine communication, the master device 110 is also required to perform time synchronization with the submarine master base station 170, so that all submarine master base stations 170 have a unified time reference. In the submarine cable communication system of a multi-node device, the master device 110 may send first measurement optical signals to submarine master base stations 170, respectively, to obtain a link length difference between respective submarine master base stations 170 and the master device 110. According to step S300, the to-be-compensated deviation is obtained and time synchronization of each submarine master base station 170 is compensated for, so as to improve time synchronization precision of the multi-node submarine cable communication system.

It should be understood that the manner for compensating for the time synchronization between the master device and the slave device that is provided in steps S310 and S320 is only a feasible implementation provided in the embodiments of the present disclosure. For optical relay systems with different structures, different time synchronization compensation manners may be used to compensate for the time deviation between the master device and the slave device.

FIG. 11 is a schematic diagram of a structure of a loop submarine cable communication system according to an embodiment of the present disclosure.

In some other embodiments of the present disclosure, as shown in FIG. 11, the method for synchronizing a master device and a slave device in time provided in the present disclosure may also be applied to a loop submarine cable communication system, which includes a shore base station 101, an optical repeater 130, an optical cable 140, a branch unit 160, and a submarine master base station 170. The shore base station 101 may serve as both a terminal receiving device and a terminal sending device of the loop submarine cable communication system.

As shown in FIG. 11, the shore base station 101 may include a reference clock 102, a time compensation module 103, a service module 104, a COTDR module 105 and a combining and distribution optical module 106. The reference clock 102 may be configured to receive time from a GPS satellite and/or a Beidou navigation satellite, and the time obtained by the reference clock 102 may be used as reference time for the loop submarine cable communication system to perform time synchronization.

The time compensation module 103 may be configured to compensate for a time synchronization deviation for the submarine master base station 170 in the loop submarine cable communication system based on measurement and processing results. The service module 104 is configured to implement service generation and sending/receiving of the loop submarine cable communication system. The COTDR module 105 may be configured to measure a link length difference of transmission links between the shore base station 101 and each submarine master base station 170, so as to perform time deviation compensation for each submarine master base station 170, thereby improving the time synchronization precision.

In the embodiments, after the loop submarine cable communication system is powered on, the shore base station 101 uses the COTDR module 105 to measure the sending link and the receiving link, respectively, to obtain COTDR measurement results.

Subsequently, by using the manner of determining the link length difference that is provided in the foregoing embodiments, a corresponding to-be-compensated time deviation Δt_{L} is obtained by the time compensation module 103, and then compensating for the time deviation is performed based on the to-be-compensated time deviation Δt_{L}.

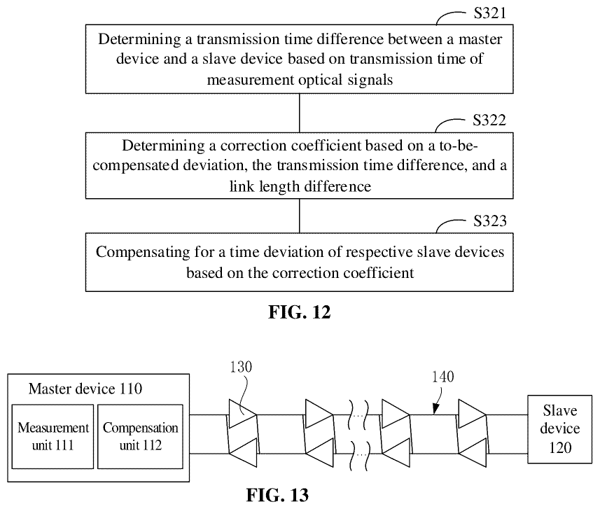

FIG. 12 is a schematic flowchart of a time deviation compensation of a loop system according to an embodiment of the present disclosure.

In this embodiment, there are issues of high costs and high energy consumption during operation in the loop system because all master and slave devices are disposed in the shore base station 101, and a COTDR is disposed in the submarine master base station 170 to obtain a link length difference of links between the shore base station 101 and the submarine master base station 170. Therefore, other manners may also be used to compensate for a time deviation of the submarine master base station 170 in the loop system. As shown in FIG. 12, the process of compensating for the submarine master base station 170 may include the following steps S321 to S323.

S321. Determining a transmission time difference between the master device and the slave device based on the transmission time of the measurement optical signals.

First, the shore base station 101 may be configured to determine the transmission time difference between the master device 110 and the slave device 120 based on the transmission time of the measurement optical signal. Because both the master device 110 and the slave device 120 are integrated into the shore base station 101, the shore base station 101 may be configured to determine a transmission time difference Δt₀ based on a receive/transmit timestamp of the measurement optical signal.

S322. Determining a correction coefficient based on the to-be-compensated deviation, the transmission time difference, and the link length difference.

Subsequently, the shore base station 101 may be configured to determine a correction coefficient for each submarine master base station 170 based on the to-be-compensated deviation, the transmission time difference, and the link length difference.

Illustratively, the correction coefficient satisfies that k=Δt_{L}/Δt₀ΔL, wherein Δt_{L} represents the to-be-compensated deviation, Δt₀ represents the transmission time difference, and ΔL represents the link length difference. Based on a relationship between parameters in the correction coefficient k, the correction coefficient k may represent a time deviation of a link difference per unit length.

S323. Compensating for a time deviation of respective slave devices based on the correction coefficient.

After the correction coefficient k is obtained, the shore base station 101 may compensate for the time deviation of respective slave devices based on the correction coefficient k. It should be understood that the submarine master base station 170 in the loop system is the device in the loop system on which time deviation needs to be compensated for.

After the correction coefficient k is obtained, the shore base station 101 may be configured to determine a length difference ΔLₓ between a sending fiber and a receiving fiber for each submarine master base station 170 and the shore base station 101 based on positions of the submarine master base stations 170 in the loop system. The length difference ΔLₓ between the sending fiber and the receiving fiber may be determined based on the first length value obtained in the foregoing embodiments, or may be measured by using the COTDR module 105 in the shore base station 101. A manner for the shore base station 101 to obtain the length difference ΔLₓ between the sending fiber and the receiving fiber is not limited in the present disclosure.

After the length difference ΔLₓ between the sending fiber and the receiving fiber is obtained by the shore base station 101, the time compensation module 103 may obtain a time deviation Δtₓ of each submarine master base station 170 relative to the shore base station 101 based on the correction coefficient k and the length difference ΔLₓ between the sending fiber and the receiving fiber. Specifically, it is satisfied that Δtₓ=kΔLₓ=Δt_{L}ΔLₓ/Δt₀Δ_{L}.

Subsequently, the time compensation module 103 may compensate for a time deviation of each submarine master base station 170 in the loop system based on the time deviation Δtₓ, so as to improve time synchronization precision of the loop system.

According to the method provided in the foregoing embodiments, in a long-range optical fiber communication system with an optical relay system, it is possible to determine lengths of the sending link and the receiving link by using the measurement optical signals, and obtain the link length difference. Thus, the system can compensate for the time deviation caused by asymmetric sending and receiving links between the master device and the slave device during time synchronization by using the link length difference, thereby improving the time synchronization precision for the master device and the slave device in the system.

FIG. 13 is a schematic diagram of a structure of an optical relay system according to an embodiment of the present disclosure.

According to the method for synchronizing a master device and a slave device in time described above, there is further provided s an optical relay system for implementing any one of the method for synchronizing a master device and a slave device in times described above in embodiments of the present disclosure. As shown in FIG. 13, the optical relay system includes at least one master device 110, at least one slave device 120, at least one optical repeater 130, and an optical fiber 140. A sending link and a receiving link are established between the master device 110 and the slave device 120 through the optical fiber 140, and the optical repeater 130 is disposed on the sending link and the receiving link.

The master device 110 may include a measurement unit 111 and a compensation unit 112. The measurement unit 111 may be configured to implement the method corresponding to step S100 in the foregoing embodiments, that is, to obtain first link length values and second link length values by using measurement optical signals. The compensation unit 112 may be configured to implement the method corresponding to steps S200 to S300 in the foregoing embodiments, that is, to obtain a link length difference between a first transmission link and a second transmission link based on a difference between each first link length value and the corresponding second link length value, and compensate for a time deviation between the master device 110 and the slave device 120 based on the link length difference.

It should be understood that the optical relay system provided in the present disclosure may also have other structures, such as the submarine cable communication system and the loop system shown in FIG. 10 and FIG. 11. A specific structure of the optical relay system is not limited in the present disclosure.

Through the description of the foregoing implementations, it can be clearly understood for those skilled in the art that the above functional modules are divided and illustrated only as examples for the sake of descriptive convenience and conciseness. In actual implementations, the described functions can be allocated to different functional modules as needed—that is, the internal structure of the device can be divided into different functional modules to achieve all or part of the aforementioned functions.

In several embodiments provided in the present disclosure, it should be understood that the disclosed device and method may be implemented in other manners. For example, the device embodiments described above are merely exemplary. For example, the division of modules or units is only a division of logical functions. In actual implementations, there may be other division manners. For example, a plurality of units or components may be combined or may be integrated into another device, or some features may be ignored or not implemented. In addition, the displayed or discussed mutual coupling or direct coupling or communication connection may be indirect coupling or communication connections through some interfaces, devices, or units, and may be in electrical or other forms.

The units described as separated parts may be or may not be physically separated; and parts displayed as units may be one or more physical units, that is, may be located at one place or may be distributed to a plurality of different places. Some or all of the units may be selected according to actual requirements to achieve the objectives of the solutions of the embodiments.

In addition, all functional units in the embodiments of the present disclosure may be integrated into one processing unit, or each unit may exist alone physically, or two or more units may be integrated into one unit. The foregoing integrated unit may be implemented in a form of hardware, or may be implemented in a form of a software functional unit.

The integrated unit may be stored in a readable storage medium if it is implemented in a form of a software functional unit and is sold or used as an independent product. On the basis of such understanding, the technical solutions in the embodiments of the present disclosure essentially, or some of the technical solutions that attribute to the prior art, or all or some of the technical solutions may be represented in a form of a software product. This software product is stored in a storage medium, and includes a plurality of instructions to enable one device (which may be a single-chip microcomputer or a chip) or a processor to implement all or some steps of the method according to the embodiments of the present disclosure. Moreover, the foregoing storage medium includes: a U disk, a portable hard disk, a read-only memory (ROM), a random access memory (RAM), a magnetic disk, a compact disc, or other media that can store program code.

The foregoing content is merely specific implementations of the present disclosure, but the protection scope of the present disclosure is not limited thereto. Any change or replacement within the technical scope disclosed in the present disclosure shall fall within the protection scope of the present disclosure. Therefore, the protection scope of the present disclosure shall be determined by the protection scope of the claims.

What is claimed is:

1. A method for synchronizing a master device and a slave device in time, comprising:
obtaining a first link length value and a second link length value by using measurement optical signals, wherein the first link length value is a measured transmission length value between the master device and an optical repeater or between the master device and the slave device in a first transmission link comprising a link through which the master device sends an optical signal to the slave device, and the second link length value is a measured transmission length value between the slave device and the optical repeater or between the slave device and the master device in a second transmission link comprising a link through which the slave device sends an optical signal to the master device;
obtaining a link length difference between the first transmission link and the second transmission link based on a difference between the first link length value and the second link length value; and
compensating for a time deviation between the master device and the slave device based on the link length difference.

2. The method according to claim 1, wherein the measurement optical signals comprise a first measurement optical signal and a second measurement optical signal, and the obtaining a first link length value and a second link length value by using measurement optical signals comprises:
sending the first measurement optical signal to the slave device by using the master device;
obtaining the first link length value based on the first measurement optical signal;
sending the second measurement optical signal to the master device by using the slave device; and
obtaining the second link length value based on the second measurement optical signal.

3. The method according to claim 2, wherein
the obtaining the first link length value based on the first measurement optical signal comprises:
obtaining a first scattering peak position and first transmission time of the first measurement optical signal; and
determining, based on the first scattering peak position and the first transmission time, the first link length value that comprises at least one first span comprising at least one of a link between the master device and the optical repeater, a link between two adjacent optical repeaters, and a link between the optical repeater and the slave device in the first transmission link; and
the obtaining the second link length value based on the second measurement optical signal comprises:
obtaining a second scattering peak position and second transmission time of the second measurement optical signal; and
determining, based on the second scattering peak position and the second transmission time, the second link length value that comprises at least one second span comprising at least one of a link between the slave device and the optical repeater, a link between two adjacent optical repeaters, and a link between the optical repeater and the master device in the second transmission link.

4. The method according to claim 3, wherein the obtaining a link length difference between the first transmission link and the second transmission link based on a difference between the first link length value and the second link length value comprises:
obtaining, based on the first scattering peak position and the second scattering peak position, the first span corresponding to the first link length value and the second span corresponding to the second link length value, respectively;
determining, based on the first span corresponding to the first link length value and the second span corresponding to the second link length value, a first length coefficient corresponding to the first link length value and/or the second link length value, wherein the first length coefficient comprises a quantity of first spans comprised in the first link length value and/or second spans comprised in the second link length value; and
obtaining the link length difference based on the first length coefficient.

5. The method according to claim 4, wherein the obtaining the link length difference based on the first length coefficient comprises:
for each first span and corresponding second span, determining first lengths of the first span and the second span;
determining a first length difference between the first span and the second span based on the first length coefficient, the first lengths, the first link length value, and the second link length value; and
obtaining the link length difference based on the determined first length differences.

6. The method according to claim 5, wherein the determining a first length difference between the first span and the second span based on the first length coefficient, the first length, the first link length value, and the second link length value comprises:
determining a relationship between the first link length value and the first length and a relationship between the second link length value and the first length based on the first length coefficient and the first length;
determining the second link length value based on the first length coefficient; and
determining the first length difference between the first span and the second span based on a difference between the relationship between the first link length value and the first length and the relationship between the second link length value and the first length.

7. The method according to claim 5, wherein the determining a first length difference between the first span and the second span based on the first length coefficient, the first length, the first link length value, and the second link length value further comprises:
determining a relationship between the first link length and the first length and a relationship between the second link length and the first length based on the first length coefficient and the first length;
determining the second link length based on the first length coefficient;
determining first length values for the first lengths in sequence based on the relationship between the first link length and the first length and the relationship between the second link length and the first length; and
determining the first length difference based on the first length values.

8. The method according to claim 5, wherein the obtaining the link length difference based on the determined first length differences comprises:
determining the link length difference based on a sum of all first length differences.

9. The method according to claim 5, wherein before the obtaining a link length difference based on a difference between the first link length value and the second link length value, the method further comprises:
determining a first arrangement sequence for the first span and the second span based on a transmission sequence of the first measurement optical signal in the first transmission link and a transmission sequence of the second measurement optical signal in the second transmission link; and
determining the second span based on the first arrangement sequence.

10. The method according to claim 1, wherein the compensating for a time deviation between the master device and the slave device based on the link length difference comprises:
obtaining a to-be-compensated deviation based on a transmission speed of the measurement optical signals and the link length difference; and
compensating for the time deviation between the master device and the slave device based on transmission time of the measurement optical signals and the to-be-compensated deviation.

11. The method according to claim 10, wherein the compensating for the time deviation between the master device and the slave device based on transmission time of the measurement optical signals and the to-be-compensated deviation comprises:
determining a transmission time difference between the master device and the slave device based on the transmission time of the measurement optical signals;
determining a correction coefficient based on the to-be-compensated deviation, the transmission time difference, and the link length difference; and
compensating for a time deviation of the slave device based on the correction coefficient.

12. Aₙ optical relay system, comprising at least one master device, at least one slave device, at least one optical repeater, and an optical fiber, wherein
a sending link and a receiving link are established between the master device and the slave device through the optical fiber, and the optical repeater is disposed on the sending link and the receiving link;
the master device comprises:
a measurement unit, configured to obtain multiple first link length values and multiple second link length values by using measurement optical signals, wherein the first link length value is a measured transmission length value between the master device and any optical repeater or between the master device and the slave device in a first transmission link comprising a link through which the master device sends an optical signal to the slave device, and the second link length value is a measured transmission length value between the slave device and the optical repeater or between the slave device and the master device in a second transmission link comprising a link through which the slave device sends a further optical signal to the master device; and
a compensation unit, configured to obtain a link length difference between the first transmission link and the second transmission link based on a difference between each first link length value and the corresponding second link length value, and compensate for a time deviation between the master device and the slave device based on the link length difference.

13. A non-transitory computer-readable storage medium storing a computer program, which, when executed by a processor, causes the processor to implement a method for synchronizing a master device and a slave device in time, comprising:
obtaining a first link length value and a second link length value by using measurement optical signals, wherein the first link length value is a measured transmission length value between the master device and an optical repeater or between the master device and the slave device in a first transmission link comprising a link through which the master device sends an optical signal to the slave device, and the second link length value is a measured transmission length value between the slave device and the optical repeater or between the slave device and the master device in a second transmission link comprising a link through which the slave device sends an optical signal to the master device;
obtaining a link length difference between the first transmission link and the second transmission link based on a difference between the first link length value and the second link length value; and
compensating for a time deviation between the master device and the slave device based on the link length difference.

14. The storage medium according to claim 13, wherein the measurement optical signals comprise a first measurement optical signal and a second measurement optical signal, and the obtaining a first link length value and a second link length value by using measurement optical signals comprises:
sending the first measurement optical signal to the slave device by using the master device;
obtaining the first link length value based on the first measurement optical signal;
sending the second measurement optical signal to the master device by using the slave device; and
obtaining the second link length value based on the second measurement optical signal.

15. The storage medium according to claim 14, wherein
the obtaining the first link length value based on the first measurement optical signal comprises:
obtaining a first scattering peak position and first transmission time of the first measurement optical signal; and
determining, based on the first scattering peak position and the first transmission time, the first link length value that comprises at least one first span comprising at least one of a link between the master device and the optical repeater, a link between two adjacent optical repeaters, and a link between the optical repeater and the slave device in the first transmission link; and
the obtaining the second link length value based on the second measurement optical signal comprises:
obtaining a second scattering peak position and second transmission time of the second measurement optical signal; and
determining, based on the second scattering peak position and the second transmission time, the second link length value that comprises at least one second span comprising at least one of a link between the slave device and the optical repeater, a link between two adjacent optical repeaters, and a link between the optical repeater and the master device in the second transmission link.

16. The storage medium according to claim 15, wherein the obtaining a link length difference between the first transmission link and the second transmission link based on a difference between the first link length value and the second link length value comprises:
obtaining, based on the first scattering peak position and the second scattering peak position, the first span corresponding to the first link length value and the second span corresponding to the second link length value, respectively;
determining, based on the first span corresponding to the first link length value and the second span corresponding to the second link length value, a first length coefficient corresponding to the first link length value and/or the second link length value, wherein the first length coefficient comprises a quantity of first spans comprised in the first link length value and/or second spans comprised in the second link length value; and
obtaining the link length difference based on the first length coefficient.

17. The storage medium according to claim 16, wherein the obtaining the link length difference based on the first length coefficient comprises:
for each first span and corresponding second span, determining first lengths of the first span and the second span;
determining a first length difference between the first span and the second span based on the first length coefficient, the first lengths, the first link length value, and the second link length value; and
obtaining the link length difference based on the determined first length differences.

18. The storage medium according to claim 17, wherein the determining a first length difference between the first span and the second span based on the first length coefficient, the first length, the first link length value, and the second link length value comprises:
determining a relationship between the first link length value and the first length and a relationship between the second link length value and the first length based on the first length coefficient and the first length;
determining the second link length value based on the first length coefficient; and
determining the first length difference between the first span and the second span based on a difference between the relationship between the first link length value and the first length and the relationship between the second link length value and the first length.

19. The storage medium according to claim 17, wherein the determining a first length difference between the first span and the second span based on the first length coefficient, the first length, the first link length value, and the second link length value further comprises:
determining a relationship between the first link length and the first length and a relationship between the second link length and the first length based on the first length coefficient and the first length;
determining the second link length based on the first length coefficient;
determining first length values for the first lengths in sequence based on the relationship between the first link length and the first length and the relationship between the second link length and the first length; and
determining the first length difference based on the first length values.

20. The storage medium according to claim 17, wherein the obtaining the link length difference based on the determined first length differences comprises:
determining the link length difference based on a sum of all first length differences.
